(19) United States
(12) Patent Application Publication
(10) Pub. No.: US 2022/0243885 A1
(43) Pub. Date: Aug. 4, 2022

(54) VEHICULAR LAMP AND VEHICLE FRONT DETECTION SYSTEM

(71) Applicant: STANLEY ELECTRIC CO., LTD., Meguro-ku, Tokyo (JP)

(72) Inventor: Yuta YAMAGUCHI, Tokyo (JP)

(73) Assignee: STANLEY ELECTRIC CO., LTD., Meguro-ku, Tokyo (JP)

(21) Appl. No.: 17/616,204

(22) PCT Filed: Jun. 2, 2020
(86) PCT No.: PCT/JP2020/021768

§ 371 Date: Dec. 3, 2021

(30) Foreign Application Priority Data
Jun. 7, 2019 (JP) 2019-107042

(51) Int. Cl. F21S 41/14; F21S 41/176; G02B 26/10; G01S 17/89; B60Q 1/00

(52) U.S. Cl. CPC F21S 41/18; F21S 41/176; B60Q 1/0023; G01S 17/89; G02B 26/10

(57) ABSTRACT

A vehicular lamp configured to radiate illumination light and measuring light toward a side in front of a vehicle includes a light source unit configured to emit visible light that becomes illumination light and measuring light, and the light source unit emits the illumination light and the measuring light while alternately switching the illumination light and the measuring light at a cycle in which at least the measuring light is not visually recognized by a driver.

### TECHNICAL FIELD

The present invention relates to a vehicular lamp and a vehicle front detection system.

Priority is claimed on Japanese Patent Application No. 2019-107042, filed Jun. 7, 2019, the content of which is incorporated herein by reference.

### BACKGROUND ART

In recent years, illumination light has been obtained using a laser light source by radiating a laser beam emitted from a laser light source such as a laser diode (LD) or the like, in which high brightness and high output light is obtained, to a fluorescent plate (a wavelength conversion member).

In such a light source unit, white light (illumination light) can be obtained by mixing blue light and yellow light through combination of a laser light source configured to emit a blue laser beam and a fluorescent plate configured to emit yellow light (fluorescence light) of which a wavelength has been converted, which is obtained by excitation with the blue laser beam (excitation light). In addition, in the light source unit using the laser light source, white light can also be obtained by synthesizing laser beams having a plurality of colors (for example, three colors of red (R), green (G) and blue (B)) on the same optical axis.

In addition, in a vehicular lamp including such a light source unit, as illumination light, a passing beam (a low beam) that forms a light distribution pattern for a low beam including a cutoff line on an upper end and a traveling beam (a high beam) that forms a light distribution pattern for a high beam above the light distribution pattern for a low beam are radiated to a side in front of the vehicle.

Meanwhile, in a vehicular lamp, in order to improve safety upon driving, a vehicle front detection system configured to radiate measuring light toward a side in front of the vehicle in addition to the above mentioned illumination light and to detect a state in front of the vehicle while receiving (imaging) the measuring light reflected and returned from the side in front of the vehicle by using an imaging device has been proposed (for example, see the following Patent Literature 1 and 2). Such a vehicle front detection system is expected to be applied to an automatic driving system or an advanced driver-assistance system.

### CITATION LIST

### Patent Literature

### [Patent Literature 1]

Japanese Unexamined Patent Application, First Publication No. 2016-099635

### [Patent Literature 2]

Japanese Unexamined Patent Application, First Publication No. 2018-142921

### SUMMARY OF INVENTION

### Technical Problem

Incidentally, in the vehicle front detection system in the related art, measuring light, which is invisible to the human eye, such as infrared light, millimeter waves, or the like, is used to detect, for example, obstacles on a road surface, unevenness on a road surface, or the like. In addition, it is necessary to dispose a light source configured to emit measuring light into a lighting body, in addition to a light source configured to emit visible light that becomes illumination light. For this reason, an increase in cost of the vehicular lamp is caused by an increase in the number of light sources.

Meanwhile, by using the above mentioned light source unit, when illumination light and measuring light, which are obtained by scanning a fluorescent plate with a laser beam or synthesizing laser beams with a plurality of colors on the same optical axis, are radiated toward a side in front of the vehicle, the measuring light becomes the same white light (visible light) as the illumination light. In this case, a driver will always visually recognize the measuring light, which may cause annoyance during driving.

Further, in a case in which distant road surface states are detected, it is difficult to obtain an illuminance necessary to detect distant road surface states only with the illumination light obtained by the above-mentioned high beam. Accordingly, the illuminance degree of the measuring light radiated toward a distant road surface needs to be higher than the illuminance degree of the illumination light.

However, it is difficult to simultaneously radiate measuring light and illumination light having an illuminance sufficient to detect distant road surface states by using the above-mentioned light source unit. Meanwhile, if a light source for measurement is added or millimeter wave radar are used, it becomes possible to detect distant road surface states, but it causes an increase in cost of the above-mentioned vehicular lamp.

An aspect of the present invention provides a vehicular lamp capable of obtaining measuring light with a sufficient illuminance while preventing measuring light from being visually recognized by a driver even in a case visible light is used as measuring light, and a vehicle front detection system capable of appropriately detecting a state in front of a vehicle using such vehicular lamp.

### Solution to Problem

An aspect of the present invention provides the following configurations.

(1) A vehicular lamp configured to radiate illumination light and measuring light toward a side in front of a vehicle, the vehicular lamp including:

a light source unit configured to emit visible light that becomes the illumination light and the measuring light,

wherein the light source unit emits the illumination light and the measuring light while alternately switching the illumination light and the measuring light at a cycle in which at least the measuring light is not visually recognized by a driver.

(2) The vehicular lamp according to the above-mentioned (1), wherein one light distribution pattern is formed by overlapping a light distribution pattern for illumination, which is formed by a radiation of the illumination light, and a light distribution pattern for measurement which is formed by a radiation of the measuring light.

(3) The vehicular lamp according to the above-mentioned (2), wherein an illuminance degree of the light distribution pattern for measurement is relatively higher than an illuminance degree of the light distribution pattern for illumination.

(4) The vehicular lamp according to the above-mentioned (2) or (3), wherein the light source unit includes:

a laser light source configured to emit a laser beam;

a visible light conversion member that includes a radiation region to which the laser beam is radiated and that is configured to convert the laser beam radiated to the radiation region into visible light; and

a laser beam scanning mechanism configured to repeatedly scan the laser beam radiated toward the radiation region at a predetermined cycle,

wherein, among the radiation region, the visible light conversion member includes at least a radiation region for illumination light that forms the light distribution pattern for illumination and a radiation region for measuring light that forms the light distribution pattern for measurement, and

the laser beam scanning mechanism scans a laser beam with respect to the radiation region for illumination light at a timing when the illumination light is emitted and scans a laser beam with respect to the radiation region for measuring light at a timing when the measuring light is emitted.

(5) The vehicular lamp according to the above-mentioned (4), wherein the laser beam scanning mechanism scans a laser beam with a predetermined frequency f and scans a laser beam with respect to the radiation region for illumination light and the radiation region for measuring light at a cycle that is a multiple of 1/f.

(6) The vehicular lamp according to the above-mentioned (5), wherein the frequency f is at least 60 Hz or more.

(7) The vehicular lamp according to any one of the above-mentioned (1) to (5), wherein a cycle where the measuring light is emitted is at least 1/60 seconds or less.

(8) A vehicle front detection system including:

the vehicular lamp according to any one of the above-mentioned (1) to (7); and

an imaging device configured to receive measuring light reflected and returned from a side in front of the vehicle,

wherein a state in front of the vehicle is detected based on a measuring light received by the imaging device.

(9) The vehicle front detection system according to the above-mentioned (8), wherein a timing when the vehicular lamp emits the measuring light and a timing when the imaging device receives the measuring light are synchronized with each other.

### Advantageous Effects of Invention

According to the present invention, it is possible to provide a vehicular lamp capable of obtaining measuring light with a sufficient illuminance while preventing measuring light from being visually recognized by a driver even in a case visible light is used as measuring light, and a vehicle front detection system capable of appropriately detecting a state in front of a vehicle using such vehicular lamp.

### BRIEF DESCRIPTION OF DRAWINGS

FIG. 1 is a block diagram showing a configuration of a vehicle front detection system according to an embodiment of the present invention.

FIG. 2 is a front view showing a configuration of a vehicular lamp included in the vehicle front detection system shown in FIG. 1.

FIG. 3 is a schematic view showing a configuration of a transmissive type light source unit included in the vehicle front detection system shown in FIG. 1.

FIG. 4 is a schematic view showing a configuration of reflective type light source unit included in the vehicle front detection system shown in FIG. 1.

FIG. 5A is a schematic view showing a light distribution pattern for illumination formed on a surface of a virtual vertical screen by illumination light emitted from the light source unit.

FIG. 5B is a schematic view showing a light distribution pattern for measurement formed on a surface of a virtual vertical screen by measuring light emitted from the light source unit.

FIG. 5C is a schematic view showing a light distribution pattern for a high beam formed on a surface of a virtual vertical screen by illumination light and measuring light emitted from the light source unit.

FIG. 6 is a plan view showing an example of a radiation region for illumination light and a radiation region for measuring light provided in a surface of a fluorescent plate.

FIG. 7 is a plan view showing a different scanning trajectory of a laser beam with respect to the radiation region for measuring light shown in FIG. 6.

FIG. 8 is a timing chart for describing an example of a timing of illumination light and measuring light radiated from the light source unit and a timing when a imaging device receives measuring light.

### DESCRIPTION OF EMBODIMENTS

Hereinafter, an embodiment of the present invention will be described with reference to the accompanying drawings.

Further, in the drawings used in the following description, in order to make components easier to see, scales of dimensions may be shown differently depending on the components, and dimensional ratios or the like of the components are not always the same as the actual ones.

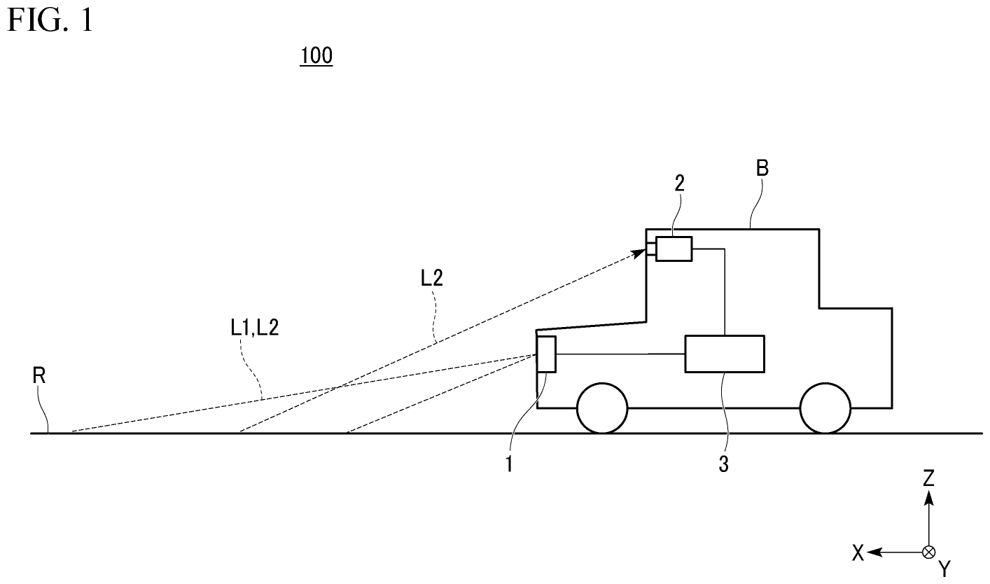

As an embodiment of the present invention, for example, a vehicle front detection system 100 shown in FIG. 1 will be described. Further, FIG. 1 is a block diagram showing a configuration of the vehicle front detection system 100.

In addition, in the following drawings, an XYZ orthogonal coordinates system is set, an X-axis direction indicates a forward/rearward direction (a lengthwise direction) with respect to a vehicle B, a Y-axis direction indicates a leftward/rightward direction (a widthwise direction) with respect to the vehicle B, and a Z-axis direction indicates an upward/downward direction (a height direction) with respect to the vehicle B.

Further, in the following description, descriptions of “forward,” “rearward,” “leftward,” “rightward,” “upward” and “downward” mean directions when the vehicle B is seen from a front surface (a side in front of the vehicle) unless the context clearly indicates otherwise.

As shown in FIG. 1, the vehicle front detection system 100 of the embodiment generally includes vehicular lamps 1 disposed at both corner portions of a front end side of the vehicle B, an imaging device 2 mounted on the vehicle B, and a vehicle front detection control device (hereinafter, referred to as “a control device”) 3 electrically connected to the vehicular lamps 1 and the imaging device 2.

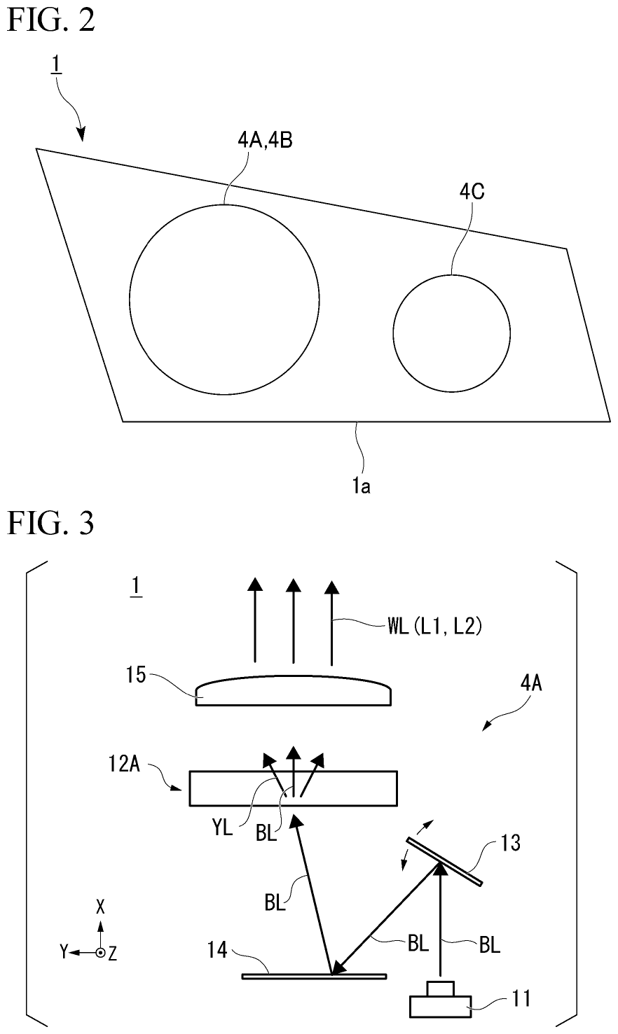

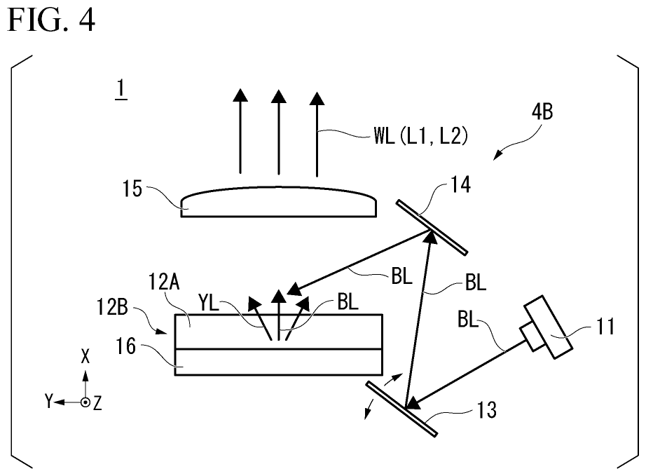

The vehicular lamp 1 is configured to radiate measuring light L2 toward a distant road surface R separately from illumination light L1 radiated toward a side in front of the vehicle B, and for example, includes a transmissive type light source unit 4A as shown in FIG. 3 or a reflective type light source unit 4B as shown in FIG. 4, and a light source unit 4C for a low beam, which will be described below, disposed inside of a lighting body 1a shown in FIG. 2.

Further, FIG. 2 is a front view showing a configuration of the vehicular lamp 1. FIG. 3 is a schematic view showing a configuration of the transmissive type light source unit 4A. FIG. 4 is a schematic view showing a configuration of the reflective type light source unit 4B.

The imaging device 2 is constituted by a camera including an imaging element such as a CCD or CMOS image sensor or the like. In the embodiment, the imaging device 2 is installed on an inner upper section of a front windshield of the vehicle B.

Further, an installation place of the imaging device 2 may be a position at which the measuring light L2 of the vehicle B can be received, and for example, an imaging element can be disposed inside of the lighting body 1a that constitutes the vehicular lamp 1 and can also be configured integrally with the vehicular lamp 1. In addition, the imaging device 2 is not limited to a dedicated camera mounted on the vehicle B according to the vehicle front detection system 100, and a conventional camera mounted on the vehicle B can also be used.

The control device 3 is configured to identify and control a state in front of the vehicle B, for example, the distant road surface R or the like on the basis of the measuring light L2 received by the imaging device 2, and for example, is constituted by a computer such as an ECU or the like. The control device 3 deploys a control program stored on an ROM in the ECU to a RAM in the ECU and executes it, and identification control with respect to a state in front of the vehicle B is performed according to a processed result thereof.

In addition, the control device 3 performs lighting control of the illumination light L1 and the measuring light L2 emitted from the vehicular lamp 1, which will be described below, and also performs control of synchronizing a timing when the vehicular lamp 1 emits the measuring light L2 and a timing when the imaging device 2 receives the measuring light L2 with each other.

As shown in FIG. 3, the transmissive type light source unit 4A generally includes a laser light source 11 configured to emit a laser beam BL that is excitation light, a transmissive type fluorescent plate 12A excited by radiation of the laser beam BL and configured to emit fluorescence light YL, a wavelength of which is converted, a laser beam scanning mechanism 13 configured to scan the laser beam BL radiated to the fluorescent plate 12A, a reflector 14 configured to reflect the laser beam BL scanned by the laser beam scanning mechanism 13 towards the fluorescent plate 12A, and a projection lens 15 configured to project the illumination light L1 and the measuring light L2 toward a side in front of the vehicle B.

The laser light source 11 is constituted by a laser diode (LD) configured to emit, for example, a blue laser beam (an emission wavelength is about 450 nm) as the laser beam BL. Further, the laser light source 11 may be an LD configured to emit an ultraviolet laser beam as the laser beam BL.

The fluorescent plate 12A is constituted by a plate-shaped wavelength conversion member including yellow fluorescent particles excited by radiation of the laser beam BL and configured to emit yellow light as the fluorescence light YL. In the embodiment, as the wavelength conversion member, for example, a member containing fluorescent particles constituted by a composite (sintered body) of YAG and alumina (Al₂O₃) into which an activator such as cerium (Ce) or the like is introduced is used. Further, the fluorescent plate 12A may be configured to contain a diffusing agent to control light distribution properties of the illumination light L1 and the measuring light L2 emitted from the light source unit 4A, in addition to the fluorescent particles.

The laser beam scanning mechanism 13 is constituted by micro-electro-mechanical systems (MEMS) mirrors disposed in an optical path between the laser light source 11 and the fluorescent plate 12A. The MEMS mirror is a movable mirror using a MEMS technology, which controls a scanning direction and a scanning speed of the laser beam BL scanned two-dimensionally in a surface of the fluorescent plate 12A.

The reflector 14 is constituted by a mirror disposed in an optical path between the fluorescent plate 12A and the laser beam scanning mechanism 13. The reflector 14 reflects the laser beam BL reflected by the MEMS mirrors toward a back surface of the fluorescent plate 12A.

In the transmissive type light source unit 4A, some of the laser beams (blue light) BL radiated toward the back surface of the fluorescent plate 12A passes through the fluorescent plate 12A while being diffused and fluorescent particles in the fluorescent plate 12A are excited by radiation of the laser beam BL, and thus, the fluorescence light (yellow light) YL is emitted and white light WL (the illumination light L1 and the measuring light L2) obtained by mixing the blue light and the yellow light can be emitted toward the projection lens 15 on a forward side.

Meanwhile, as shown in FIG. 4, the reflective type light source unit 4B generally includes a laser light source 11 configured to emit laser beam BL that is excitation light, a reflective type fluorescent plate 12B excited by radiation of the laser beam BL and configured to emit fluorescence light YL, a wavelength of which is converted, a laser beam scanning mechanism 13 configured to scan the laser beam BL radiated to the fluorescent plate 12B, a reflector 14 configured to reflect the laser beam BL scanned by the laser beam scanning mechanism 13 towards the fluorescent plate 12B, and a projection lens 15 configured to project the illumination light L1 and the measuring light L2 toward a side in front of the vehicle B.

That is, the light source unit 4B includes the reflective type fluorescent plate 12B, instead of the transmissive type fluorescent plate 12A. In addition, the light source unit 4B changes disposition of the laser light source 11, the laser beam scanning mechanism 13 and the reflector 14 according to disposition of the fluorescent plate 12B. Other than that, the light source unit 4B has basically the same configuration as the transmissive type light source unit 4A.

The fluorescent plate 12B has a configuration in which a reflecting plate 16 is disposed on a back surface side of a wavelength conversion member that constitutes the fluorescent plate 12A. The reflecting plate 16 reflects the laser beam BL incident from a front surface side of the fluorescent plate 12B and the fluorescence light YL excited in the fluorescent plate 12B toward a front surface side of the fluorescent plate 12B.

In the reflective type light source unit 4B, some of laser beams (blue light) BL radiated toward a front surface of the fluorescent plate 12B is reflected by the fluorescent plate 12B while being diffused and yellow fluorescent particles in the fluorescent plate 12A are excited by radiation of the laser beam BL, and thus, fluorescence light (yellow light) YL is emitted and the white light WL (the illumination light L1 and the measuring light L2) obtained by a mixture of the blue light and the yellow light can be emitted toward the projection lens 15 on the forward side.

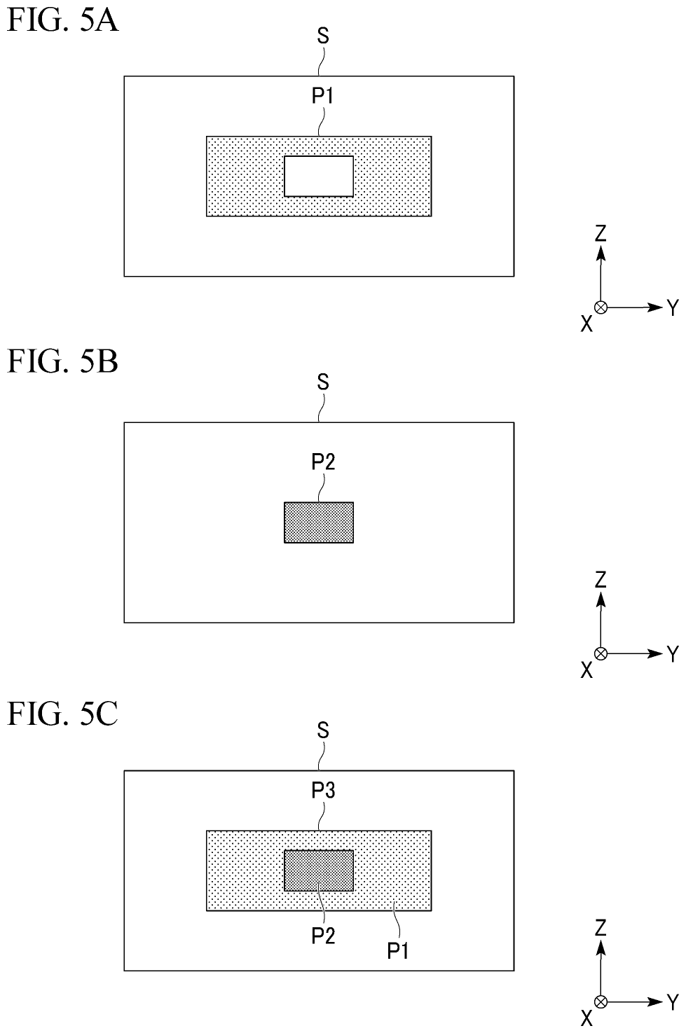

In the vehicular lamp 1 of the embodiment, as the light source units 4A and 4B are provided, the illumination light L1 that forms a light distribution pattern P1 for illumination as shown in FIG. 5A and the measuring light L2 that forms a light distribution pattern P2 for measurement as shown in FIG. 5B can be projected toward a road surface R in front of the vehicle B by the projection lenses 15, respectively.

In addition, the light source units 4A and 4B emit the illumination light L1 and the measuring light L2 while alternately switching them at a cycle in which at least the measuring light L2 is not visually recognized by a driver. Accordingly, a light distribution pattern P3 for a high beam as shown in FIG. 5C is formed.

Further, FIG. 5A is a schematic view showing the light distribution pattern P1 for illumination formed on a surface of a virtual vertical screen S by the illumination light L1 emitted from the light source units 4A and 4B. FIG. 5B is a schematic view showing the light distribution pattern P2 for measurement formed on the surface of the virtual vertical screen S by the measuring light L2 emitted from the light source units 4A and 4B. FIG. 5C is a schematic view showing the light distribution pattern P3 for a high beam formed on the surface of the virtual vertical screen S by the illumination light L1 and the measuring light L2 emitted from the light source units 4A and 4B.

Among these, the light distribution pattern P1 for illumination shown in FIG. 5A has a pattern shape corresponding to a peripheral region except for a central region among the light distribution pattern P3 for a high beam shown in FIG. 5C. Meanwhile, the light distribution pattern P2 for measurement shown in FIG. 5B has a pattern shape corresponding to the central region in the light distribution pattern P3 for a high beam shown in FIG. 5C. Accordingly, the light distribution pattern P3 for a high beam shown in FIG. 5C is formed by overlapping the light distribution pattern P1 for illumination formed by radiation of the illumination light L1 and the light distribution pattern P2 for measurement formed by radiation of the measuring light L2.

In addition, in the vehicular lamp 1 of the embodiment, the light source unit 4C for a low beam can project illumination light that serves as a low beam that forms a light distribution pattern for a low beam including a cutoff line at an upper end thereof at below the light distribution pattern P3 for a high beam toward the road surface R in front of the vehicle B.

Further, the light distribution pattern for a low beam is not limited to a case in which it is formed only by the light source unit 4C for a low beam, and for example, the light distribution pattern for a low beam can be formed by forming a region below a horizontal line by the light source unit 4C for a low beam and supplementing the cutoff line with the light source units 4A and 4B.

In the light source units 1A and 1B, a plurality of radiation regions corresponding to each light distribution patterns such as the light distribution pattern P1 for illumination, the light distribution pattern P2 for measurement, or the like, are set in the surfaces of the fluorescent plates 12A and 12B, and the laser beam BL is radiated to each of the radiation regions while scanning the laser beam BL. Accordingly, the plurality of light distribution patterns P1 and P2 that are different from each other can be formed.

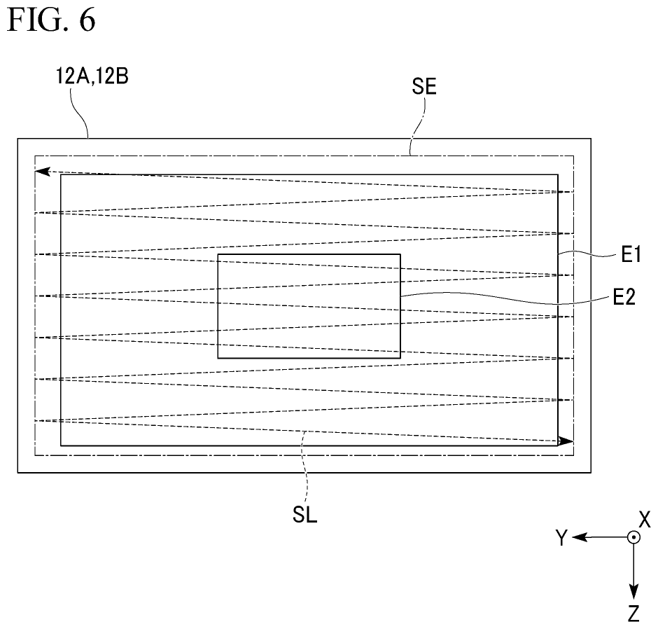

Specifically, as shown in FIG. 6, a case in which a radiation region (hereinafter, referred to as “a radiation region for illumination light) E1 that forms the light distribution pattern P1 for illumination and a radiation region (hereinafter, referred to as “a radiation region for measuring light”) E2 that forms the light distribution pattern P2 for measurement are provided in the surfaces of the fluorescent plates 12A and 12B is exemplified.

Further, FIG. 6 is a plan view showing an example of the radiation region E1 for illumination light and the radiation region E2 for measuring light provided in the surfaces of the fluorescent plates 12A and 12B. In addition, in FIG. 6, a scanning range SE of the laser beam BL scanned within the surfaces of the fluorescent plates 12A and 12B is shown by dashed lines. Further, in FIG. 6, a scanning trajectory SL of the laser beam BL scanned within the surfaces of the fluorescent plates 12A and 12B is shown by broken lines.

Within the scanning range SE which is scanned through by one scanning of the laser beam BL, the laser beam scanning mechanism 13 periodically repeats scanning of the laser beam BL from one end side toward the other end side of the scanning trajectory SL and scanning of the laser beam BL from the other end side toward the one end side of the scanning trajectory SL.

In the surfaces of the fluorescent plates 12A and 12B shown in FIG. 6, the radiation region E2 for measuring light is provided inside the radiation region E1 for illumination light in the scanning range SE. That is, the radiation region E1 for illumination light is provided to surround the radiation region E2 for measuring light.

In the light source units 1A and 1B, by radiating the laser beam BL to the radiation region E1 for illumination light and the radiation region E2 for measuring light by using the laser beam scanning mechanism 13 while scanning the laser beam BL, the illumination light L1 that forms the light distribution pattern P1 for illumination and the measuring light L2 that forms the light distribution pattern P2 for measurement can be projected toward the road surface R in front of the vehicle B by the projection lens 15.

In addition, in order to obtain a sufficient illuminance to detect a distant road surface state, the illuminance degree of the light distribution pattern for measurement P2 is relatively higher than the illuminance degree of the light distribution pattern P1 for illumination.

Further, while the above mentioned light distribution pattern P1 for illumination and the above mentioned light distribution pattern P2 for measurement have a pattern shape that divides the light distribution pattern P3 for a high beam into the central region and the peripheral region in the embodiment, it is not particularly limited to such a pattern shape. For example, the pattern shape may be a pattern shape in which the light distribution pattern P1 for illumination and the light distribution pattern P2 for measurement overlap at least partially each other, a pattern shape in which the light distribution pattern for illumination light P1 and the light distribution pattern for measuring light P2 overlap completely each other, or the like.

When the above mentioned light source units 4A and 4B are used, the laser beam BL emitted from the laser light source 11 can also be radiated to the fluorescent plates 12A and 12B in a concentrated manner such that the scanning range of the laser beam BL scanned by the laser beam scanning mechanism 13 is narrowed when the radiation region E2 for measuring light is scanned compared to when the radiation region E1 for illumination light is scanned.

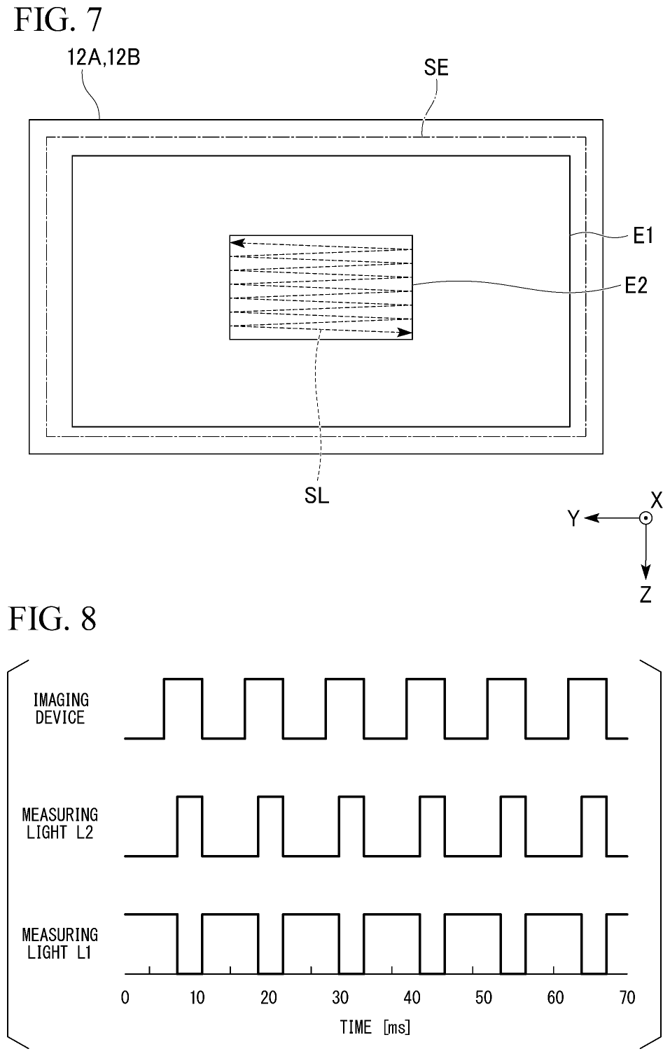

The scanning trajectory SL of the laser beam BL with respect to the radiation region E2 for measuring light at this time is shown in FIG. 7. Further, FIG. 7 is a plan view showing a different example of scanning trajectory S, of the laser beam BL with respect to the radiation region E2 for measuring light.

In this case, a wide range of the radiation region E1 for illumination light is scanned with the laser beam BL while the light distribution pattern P1 for illumination is radiated as shown in FIG. 6, and a narrow range of the radiation region E2 for measuring light is scanned with the laser beam BL while the light distribution pattern P2 for measurement is radiated as shown in FIG. 7. In addition, the laser beam scanning mechanism 13 is controlled to scan the laser beam BL at a frequency f of at least 60 Hz or more (in the embodiment, 270 Hz).

Accordingly, it is possible to make the illuminance degree of the light distribution pattern P2 for measurement relatively higher than the illuminance degree of the light distribution pattern P1 for illumination than the change in the output of the laser light source 11.

Incidentally, in the vehicular lamp 1 of the embodiment, the illumination light L1 and the measuring light L2 are emitted while being alternately switched by using the light source units 4A and 4B in a cycle in which at least the measuring light L2 is not visually recognized by a driver. Accordingly, even in a case a white light (visible light) WL same as the illumination light L1 is used as the measuring light L2, it is possible to prevent the measuring light L2 from being seen separately by the driver.

Specifically, the light source units 4A and 4B emit the illumination light L1 and the measuring light L2 in a pulse manner in a predetermined cycle, and, during the cycle when the illumination light L1 and the measuring light L2 are emitted, emit the illumination light L1 and the measuring light L2 while alternately switching a timing when the illumination light L1 is emitted and a timing when the measuring light L2 is emitted.

For this reason, the laser beam scanning mechanism 13 repeatedly scans the laser beam BL with respect to the scanning range SE of the above mentioned fluorescent plates 12A and 12B at the predetermined cycle. In addition, the laser light source 11 switches turning on/off of the laser light source 11 (ON/OFF) according to a timing when the radiation region E1 for illumination light is scanned and a timing when the radiation region E2 for measuring light is scanned in the scanning range SE. Further, the laser light source 11 can control strength of the emitted laser beam BL.

The laser beam scanning mechanism 13 scans the laser beam BL with respect to the scanning range SE at a predetermined frequency f, and scans the laser beam BL with respect to the radiation region E1 for illumination light and the radiation region E2 for measuring light at a cycle that is a multiple of 1/f. As long as the frequency f is at least 60 Hz or more, the measuring light L2 can be emitted at a cycle (1/f= 1/60 seconds (s)) in which the measuring light is not visually recognized by a driver (a human's eye).

That is, as the cycle of the measuring light L2 that is not visually recognized by the driver (human's eye), 1/60 seconds or less is preferable. When the measuring light L2 is emitted at a cycle of 1/60 seconds or less, only the light distribution pattern P3 for a high beam in which the light distribution pattern P1 for illumination and the light distribution pattern P2 for measurement overlap each other is visually recognized by the human's eye. In addition, the illuminance degree of the light distribution pattern P3 for a high beam is an illuminance degree with a time average including a non-radiation time of the illuminance of the light distribution pattern P1 for illumination and the illuminance of the light distribution pattern P2 for measurement.

In addition, in a road surface state detection system 100 of the embodiment, a timing when the vehicular lamp 1 emits the measuring light L2 and a timing when the imaging device 2 receives (images) the measuring light L2 are synchronized with each other (matched with each other) under control of the control device 3.

Accordingly, it is possible to detect a state in front of the vehicle B while receiving (imaging) the measuring light L2 reflected and returned from the side in front of the vehicle R by using the imaging device 2.

Here, a timing of the illumination light L1 and the measuring light L2 emitted from the light source units 4A and 4B and a timing when the imaging device 2 receives (images) the measuring light L2 will be described while exemplifying a case shown in FIG. 8.

Further. FIG. 8 is a timing chart for describing an example of the timing of the illumination light L1 and the measuring light L2 emitted from the light source units 4A and 4B and the timing when the imaging device 2 receives (images) the measuring light L2.

In the vehicular lamp 1 of the embodiment, as shown in FIG. 8, for example, the laser beam scanning mechanism 13 repeatedly scans the laser beam BL with respect to the scanning range SE at a frequency f of 270 Hz. Accordingly, the laser beam BL is scanned with respect to the scanning range SE 270 times per one second.

In addition, during repeating the scanning of the scanning range SE, the illumination light L1 and the measuring light L2 are alternately emitted such that a radiation time of the illumination light L1 and a radiation time of the measuring light L2 are in a ratio of 2:1 while alternately switching the timing when the illumination light L1 is emitted and the timing when the measuring light L2 is emitted.

That is, during repeating the scanning of the scanning range SE, the laser light source 11 is turned on (ON) at the timing when the radiation region E1 for illumination light is scanned in the scanning range SE, and the laser light source 11 is turned off (OFF) at the timing when the radiation region E2 for measuring light is scanned. In addition, such scanning is performed two times in successive. Accordingly, the illumination light L1 is emitted at a cycle of 2/f (= 2/270= 1/135 seconds (s)).

On the other hand, during repeating the scanning of the scanning range SE, the laser light source 11 is turned on (ON) at a timing when the radiation region E2 for measuring light is scanned in the scanning range SE, and the laser light source 11 is turned off (OFF) at a timing when the radiation region E1 for illumination light is scanned. In addition, such scanning is performed once. Accordingly, the measuring light L2 is emitted at a cycle of 1/f (= 1/270 seconds (s)).

In addition, in a case the scanning range SE of the laser beam BL is changed to a narrow range of the radiation region E2 for measuring light shown in FIG. 7, there is no need to turn off (OFF) the laser light source 11 while the light distribution pattern P2 for measurement is radiated. Accordingly, it is possible to increase the time when the laser light source 11 is turned on (ON).

In this case, the measuring light L2 having an illuminance sufficient to detect a distant road surface state can be emitted at a cycle ( 1/60 seconds or less) in which the measuring light L2 is not visually recognized by a driver (human's eye).

In addition, the one light distribution pattern P3 for a high beam can be formed by overlapping the light distribution pattern P1 for illumination formed by radiation of the illumination light L1 and the light distribution pattern P2 for measurement formed by radiation of the measuring light L2.

In this case, it is possible to form the light distribution pattern P3 for a high beam on the road surface R in front of the vehicle B by emitting the illumination light L1 and the measuring light L2 at a cycle of 3/f (= 3/270= 1/90 seconds (s)) while alternately switching the illumination light L1 and the measuring light L2 without making the driver (human's eye) feel flicker.

In addition, in the road surface state detection system 100 of the embodiment, for example, the imaging device 2 repeatedly opens a shutter (receives light) at a frame rate of 90 Hz and an exposure time of 1/180 seconds (s) while making a timing when the vehicular lamp 1 emits the measuring light L2 and a timing when the imaging device 2 receives the measuring light L2 synchronized with each other (matching with each other).

Accordingly, the measuring light L2 reflected and returned from the side in front of the vehicle B due to the radiation of the measuring light L2 can be appropriately received (imaged) by the imaging device 2.

Here, an exposure time of the imaging device is 1/180 seconds while emission of the measuring light L2 is 1/270 seconds. In addition, the light distribution pattern P2 for measurement has a 3 times of illuminance degree at ⅓ of the radiation time compared to the case in which only the conventional light distribution pattern for a high beam is radiated. Accordingly, since the imaging device 3 receives the measuring light L2 having 3 times of quantity of light in ⅔ of time, the quantity of received light becomes 2 (=3×⅔) times of the quantity of received light in comparison with the case in which only the light distribution pattern for a high beam is radiated. Accordingly, in comparison with the case in which only the conventional light distribution pattern for a high beam is radiated, the distant road surface R can be irradiated with the measuring light L2 having a sufficient illuminance.

As described above, in the vehicular lamp 1 of the embodiment, even in a case visible light is used as the measuring light L2, it is possible to prevent the measuring light L2 from being visually recognized by a driver. In addition, it is possible to obtain the measuring light L2 having an illuminance sufficient to detect a state of the distant road surface R.

Accordingly, in the vehicle front detection system 100 of the embodiment, it is possible to appropriately detect a state in front of the vehicle B by using the vehicular lamp 1.

Further, the present invention is not particularly limited to the embodiment and various modifications may be made without departing from the scope of the present invention.

For example, a ratio between the radiation times of the illumination light L1 and the measuring light L2, a scanning frequency f of the laser beam BL, and a frame rate or an exposure time of the imaging device 3, or the like, is not particularly limited to setting by the embodiment and may be arbitrarily set.

In addition, in the vehicular lamp 1, a light distribution pattern for a low beam, a light distribution pattern for road surface drawing, or the like, may be formed by using the light source units 4A and 4B, separately from the light distribution pattern P3 for a high beam. As the light distribution pattern for road surface drawing, for example, a character, a sign, a figure, or the like, may be exemplified.

In addition, the vehicular lamp 1 is not limited to the configuration in which the light source units 4A and 4B are used and may have a configuration in which illumination light and measuring light are emitted while being alternately switched at a cycle in which at least the measuring light is not visually recognized by a driver.

For example, in the above mentioned the light source units 4A and 4B, while the light source units 4A and 4B have a configuration in which the laser light source 11 emits laser beam (excited laser beam) BL that serves as excitation light and the fluorescent plates 12A and 12B are excited by the laser beam BL and configured to emit the fluorescence light YL, a wavelength of which is converted, are used, however, a configuration in which the laser light source 11 directly emits a laser beam (visible laser beam) that is visible light may be provided.

In the case of this configuration, by using a diffusion plate, which is configured to diffuse the laser beam emitted from the laser light source 11, instead of the fluorescent plates 12A and 12B, it is more preferable to radiate the laser beam while scanning the laser beam with respect to the radiation region provided in the surface of the diffusion plate. Accordingly, it is possible to emit the above mentioned illumination light L1 that forms the light distribution pattern P1 for illumination and the measuring light L2 that forms the light distribution pattern P2 for measurement.

In addition, other than the above mentioned fluorescent plates 12A and 12B or the diffusion plate, it is possible to use a visible light conversion member configured to convert an ultraviolet laser beam radiated to a radiation region into visible light.

In addition, the vehicular lamp 1 is not limited to the configuration in which the light source units 4A and 4B are used, and for example, may also have a configuration in which a light source unit configured to directly emit visible light that becomes the illumination light L1 and the measuring light L2 is used. For example, a light source unit of an LED array type in which light emitting elements (LEDs) are arranged in an array manner, an LCD type in which a liquid crystal display (LCD) is used, a DMD type in which a digital mirror device (DMD) is used, or the like, may be used.

In addition, in the road surface state detection system 100, while the measuring light L2 reflected and returned from the side in front of the vehicle B is received (imaged) by the imaging device 2 by synchronizing (matching) the timing when the vehicular lamp 1 emits the measuring light L2 and the timing when the imaging device 2 receives the measuring light L2 with each other, a configuration in which the imaging device 2 continuously performs imaging and an image imaged by radiation of the measuring light L2 is extracted from the imaged images can also be used.

Further, the road surface state detection system 100 can also be applied to an automatic driving system or an advanced driver-assistance system. That is, in the vehicle B, based on a road surface state detected by the above mentioned road surface state detection system 100, it is possible to perform automatic control such as engine control, brake control, steering control, or the like, according to the road surface state.

### REFERENCE SIGNS LIST

1 . . . vehicular lamp 2 . . . imaging device 3 . . . road surface state detection control device (control device) 4A, 4C . . . transmissive type light source unit 11 . . . laser light source 12A, 12B . . . fluorescent plate (wavelength conversion member) 13 . . . laser beam scanning mechanism 14 . . . reflector 15 . . . projection lens 100 . . . road surface state detection system L1 . . . illumination light L2 . . . measuring light BL . . . laser beam YL . . . fluorescence light WL . . . white light (visible light) P1 . . . light distribution pattern for illumination P2 . . . light distribution pattern for measurement P3 . . . light distribution pattern for a high beam E1 . . . radiation region for illumination light E2 . . . radiation region for measuring light

1. A vehicular lamp configured to radiate illumination light and measuring light toward a side in front of a vehicle, the vehicular lamp comprising:
a light source unit configured to emit visible light that becomes the illumination light and the measuring light,
wherein the light source unit emits the illumination light and the measuring light while alternately switching the illumination light and the measuring light at a cycle in which at least the measuring light is not visually recognized by a driver.

2. The vehicular lamp according to claim 1, wherein one light distribution pattern is formed by overlapping a light distribution pattern for illumination, which is formed by a radiation of the illumination light, and a light distribution pattern for measurement which is formed by a radiation of the measuring light.

3. The vehicular lamp according to claim 2, wherein an illuminance degree of the light distribution pattern for measurement is relatively higher than an illuminance degree of the light distribution pattern for illumination.

4. The vehicular lamp according to claim 2, wherein the light source unit comprises:
a laser light source configured to emit a laser beam;
a visible light conversion member that includes a radiation region to which the laser beam is radiated and that is configured to convert the laser beam radiated to the radiation region into visible light; and
a laser beam scanning mechanism configured to repeatedly scan the laser beam radiated toward the radiation region at a predetermined cycle,
wherein, among the radiation region, the visible light conversion member includes at least a radiation region for illumination light that forms the light distribution pattern for illumination and a radiation region for measuring light that forms the light distribution pattern for measurement, and
wherein the laser beam scanning mechanism scans a laser beam with respect to the radiation region for illumination light at a timing when the illumination light is emitted and scans a laser beam with respect to the radiation region for measuring light at a timing when the measuring light is emitted.

5. The vehicular lamp according to claim 4, wherein the laser beam scanning mechanism scans a laser beam with a predetermined frequency f and scans a laser beam with respect to the radiation region for illumination light and the radiation region for measuring light at a cycle that is a multiple of 1/f.

6. The vehicular lamp according to claim 5, wherein the frequency f is at least 60 Hz or more.

7. The vehicular lamp according to claim 1, wherein a cycle where the measuring light is emitted is at least 1/60 seconds or less.

8. A vehicle front detection system comprising:
the vehicular lamp according to claim 1; and
an imaging device configured to receive measuring light reflected and returned from a side in front of the vehicle,
wherein a state in front of the vehicle is detected based on a measuring light received by the imaging device.

9. The vehicle front detection system according to claim 8, wherein a timing when the vehicular lamp emits the measuring light and a timing when the imaging device receives the measuring light are synchronized with each other.
